(19) United States
(12) Patent Application Publication
(10) Pub. No.: US 2010/0233410 A1
(43) Pub. Date: Sep. 16, 2010

(54) WET-ON-WET METHOD FOR FORMING FLOCKED ADHESIVE ARTICLE

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 12/787,938

(22) Filed: May 26, 2010

Related U.S. Application Data
(63) Continuation of application No. 11/842,387, filed on Aug. 21, 2007.
Application No. 11/842,387 is a continuation-in-part of application No. 11/565,974, filed on Dec. 1, 2006.
(60) Provisional application No. 60/823,048, filed on Aug. 21, 2006.
(60) Provisional application No. 60/944,167, filed on Jun. 15, 2007.
(60) Provisional application No. 60/748,505, filed on Dec. 7, 2005.

(51) Int. Cl. B32B 7/12; B32B 33/00; B32B 37/02; B32B 37/24

(52) U.S. Cl. 428/41.6; 428/41.8; 156/60; 156/62.2

(57) ABSTRACT

A flocked article in which multiple adhesive layers or regions are formed by wet-on-wet printing techniques.

### CROSS REFERENCE TO RELATED APPLICATION

The present application is a continuation of U.S. patent application Ser. No. 11/842,387, filed Aug. 21, 2007, which (a) claims the benefits under 35 U.S.C. §119(e), of U.S. Provisional Application Ser. Nos. 60/823,048, filed Aug. 21, 2006, and 60/944,167, mailed Jun. 15, 2007, of the same title, and (b) is a continuation-in-part of U.S. patent application Ser. No. 11/565,974, filed Dec. 1, 2006, which claims the benefits of U.S. Provisional Application Ser. No. 60/748,505, filed Dec. 7, 2005, entitled “Flocked Multi-Colored Adhesive Article with Bright Luster Flock,” each of which is incorporated herein by reference.

### FIELD OF THE INVENTION

The invention relates generally to flocked articles and particularly to flocked multi-colored adhesive articles. More specifically to flocked multi-colored adhesive articles with bright lustered flock and to methods of making the same.

### BACKGROUND OF THE INVENTION

Flocked articles are used in a wide variety of applications. For example, flocked articles are used as patches, transfers, molded objects, and the like. Flock is much less expensive than woven articles and provides a “plusher” feel to the article relative to embroidered articles.

Even with flocked articles, there are varying degrees of plushness. Plushness refers to the resilience, tactile sensation, or dimension of the fiber coating and is generally a combination of one or more of the following characteristics: fiber type (e.g., durometer, softness or hardness of the plastic, resilience of the fiber itself); fiber diameter (e.g., denier or decitex); fiber density (e.g., grams per square meter); fiber cut length (e.g., mm or thousandths of an inch); evenness of the cut (unevenly cut fibers, flocked together, actually can feel softer than uniformly cut fibers); depth into the adhesive to which the fibers are planted or situated; angle of fibers in the adhesive (with a normal orientation being most desirable); uniformity of angle of fibers in the adhesive (whether most of the fibers are oriented in the same direction or in diverse directions); softness of the adhesive base resin (e.g., a base resin that has been foamed with air is generally softer); and evenness of adhesive coating (e.g., degree of uniformity of adhesive layer thickness). Plushness is sometimes further characterized by the flock's resistance or lack of resistance to touch or to a force, the fiber's resistance to bending and yielding, and also to the fiber's slipping characteristics (e.g., the longitudinal movement along a fiber with lack of resistance—easy slipping, for example, can make a soft fiber feel “wet”). More plush flocked articles generally have a higher perceived value to buyers.

As important as the plushness of a flocked article may be, it is equally desirable for the flock to have an attractive aesthetic appearance. Conventional multicolor plush direct-flocked heat transfers are typically made using multicolor “full dull” or “grand mat” type fibers, which by definition include at least about 1 wt % light dispersants, such as titanium dioxide. As will be appreciated, light dispersants are normally used to diffuse or scatter the light to eliminate unsightly and uneven shading, mottling, or shadows from light passing through the fibers. Multicolor flock products normally use a white adhesive backing that tends to reflect light, accentuate uneven characteristics, and somewhat show through the fibers or influence them by passing reflected light back through the fibers. A medium blue bright fiber, for example, would appear lighter and, as one's viewing angle shifted, one could see evidence of shading and/or pigment colors blocking or scattering the light viewed through the different flock fibers. The shading represents generally a variation in the amount of light reflected and passing back through the fiber. As a result, the fibers appear to have a dull finish and do not reflect light in contrast to the bright, light-reflective sheen that is typically seen on embroidery threads and which is associated with a high quality decoration, i.e. similar to the difference between frosted or matt glass and clear glass.

In addition to these drawbacks, the adhesives of conventional flocked articles are typically colored differently than the flock fibers themselves (with most adhesives being white as described above) and thus do not enhance or amplify the fiber color and are less visually appealing. Therefore, the off-colored adhesive must be overcome by the flock fiber colors. To adequately conceal the adhesive color, manufacturers have used relatively high flock densities, which have increased operating costs and impacted detrimentally the “feel” of the flocked surface. However, even with higher flock densities, the wear resistance of such flocked articles can be limited. As flock fibers are dislodged during use, the adhesive will be revealed, destroying the visual appeal of the article.

Manufacturers have attempted to use matching color latex adhesive behind a single color image (e.g., black latex or gold latex behind black flock or gold flock) to enhance the color of the flocked article and address the aesthetic problems associated with using an off-color adhesive. Color matching of the backing adhesive and flock fibers has had limited efficacy, however, because “full dull” flock fibers fail to provide a highly desirable brilliance or sheen to the fibers.

There is thus a need to provide a flocked article having a high degree of plushness and wear resistance, while using a lower flock density compared to existing articles.

A need also exists to provide a flocked article having a brilliant sheen and appearance, a high degree of plushness and wear resistance, while using a lower flock density compared to existing articles to enhance the soft touch without detracting from the appearance.

### SUMMARY OF THE INVENTION

These and other needs are addressed by the various embodiments and configurations of the present invention. The present invention is directed generally to decorative articles having one or more of bright or semi-bright lustered flock, multicolored adhesives, and adhesives including solidifying agents.

In one embodiment, the invention is directed to the use of bright or semi-bright lustered flock and underlying colored adhesives to realize various visual effects in the flocked product. The color of the flock may be the same as the color of the underlying adhesive. A transparent adhesive layer may also be positioned between the flock and the colored adhesive layer to provide a “frosted” effect and adhere the flock to the colored adhesive layer.

Brilliant or bright color flock fibers normally contain little or no white pigment (titanium dioxide), which is normally used to diffuse the light to eliminate unsightly shading or mottling or shadows from light passing through the fibers. Multicolor flock products normally use a white adhesive backing that would tend to show through the fibers somewhat or influence them with light reflecting off the adhesive and passing back through the fibers. A medium blue bright fiber, for example, would appear lighter and, as one's viewing angle shifted, one could see evidence of shading, which is variation in the amount of light reflected and passing back through the fiber. With normal multicolor printing with white adhesive, this is a problem but with the present invention the backing adhesive could be blue. Color matching adhesive and flock can reduce dramatically the shading effect because the same color is reflected and transmitted back through the fibers instead of white. Moreover, to realize a desired appearance, color matching permits the use of a lower flock density when compared to color mismatching with a white adhesive.

In one embodiment, the invention is directed to the use of a setting or solidifying agent to solidify and/or gel the colored adhesives, in whole or part, between adhesive printing stations. In one configuration, the agent is located in both the adhesive and a fluid applied to the adhesive. The fluid, when contacted with the adhesive, causes the adhesive to have a translucent chemical film around the printed adhesive, preferably within a substantially shorter time than is needed for the next color of adhesive in the next station to be applied. Preferably, the fluid comprises a bivalent and/or trivalent metal salt on a base of a metal from Groups IA (alkali metals), HA (alkaline earth metals), VIIB, VIIIA, IB, IIB, and IIIB of the Periodic Table of the Elements (Previous IUPAC form), and even more preferably a metal salt of magnesium and/or calcium and/or aluminum, and the adhesive includes an alginate compound (which is a derivative of alginic acid (e.g., calcium, sodium, or potassium salts or propylene glycol alginate)). As will be appreciated, alginates are normally hydrophilic colloids (hydrocolloids) obtained from seaweed. Sodium alginate, in particular, is water-soluble but reacts with calcium salts to form calcium alginate, a low solubility salt.

The use of a solidifying agent permits the various colors of adhesives to be applied relatively rapidly, generally without increasing significantly the incidence of clogging of the adhesive depositing stations. As will be appreciated, such clogging is normal when printing one wet adhesive in proximity to another wet adhesive.

Alternatively, a flash-dry mechanism could be used in combination with fast-dry inks or adhesives to solidify the first adhesive or ink prior to application of the second ink or adhesive. Further alternatively, any suitable UV-curable ink or adhesive may be used in combination with UV energy to solidify the first adhesive or ink prior to application of the second ink or adhesive.

Flock fibers can be applied by a number of techniques. For example, the fibers be applied to the colored backing material as part of a transfer or directly flocked onto the backing material.

The present invention has found that brilliant or bright luster flock fibers, containing little or no light dispersants or pigments, can provide decorative articles of a unique and surprisingly rich, lustrous, and attractive appearance. A white pigment, titanium dioxide, is normally used to diffuse the light passing through the fibers to eliminate unsightly shading or mottling or shadowing. In addition, color matching adhesive and flock can dramatically reduce the shading effect because the same or a similar color is reflected and transmitted back through the fibers to even out the color perception. For example, while red flock fibers may show shading because of the color contrast with a bright white backing latex adhesive, red flock fibers with a matching, underlying red color adhesive will generally have little, if any, internal color contrast. Moreover, to realize a desired appearance, color matching can permit the use of a lower flock density when compared to color mismatching with a white adhesive.

In a second embodiment, a multi-colored flocked article having a plurality of flock regions and a plurality of adhesive regions is provided. Each of the plurality of flock regions is defined by a plurality of flock fibers that are substantially the same in color and are substantially free of light dispersants. Preferably, the flock fibers include less than about 1 wt % light dispersants, more preferably less than about 0.5 wt % light dispersants, and even more preferably less than about 0.05 wt % light dispersants. In one configuration, the light dispersant is titanium dioxide. The flock fibers of each flock region collectively define a single color that is preferably different from the color of an adjacent flock region to form a patterned, multi-colored design.

Further, each of the plurality of adhesive regions typically corresponds to a similarly colored flock region. The phrases “at least similar” or “substantially similar” mean that the adhesive regions and corresponding flock regions have identical, substantially similar, or similar colors. In one configuration, the colored adhesives are latex adhesives and the plurality of adhesive regions are in registration with a corresponding like-colored flock region. For example, the regions may be different shades of the same color, or slightly different colors that are adjacent to one another on the color wheel.

In another embodiment, the flocked article further includes a backing adhesive and the plurality of colored adhesive regions are positioned between the flock regions and the backing adhesive.

In yet another embodiment, the flocked article further includes a release adhesive positioned between a carrier sheet and the plurality of colored flock regions positioned between the plurality of colored adhesive regions and the release adhesive.

In another embodiment, a first adhesive layer that is at least one of substantially transparent and translucent engages the flock fibers on a first surface of the first adhesive layer and colored backing regions on an opposing second surface of the first adhesive layer. The colored backing regions can further contact a second adhesive layer. Because the second adhesive layer is disposed between the flock fibers and the colored backing regions, the first and second colored backing regions do not normally contact ends of the flock fibers in the respectively corresponding flock fiber color sets. A substantially transparent adhesive layer may be positioned between the flock and the colored adhesive layer to provide a “frosted” effect and adhere the flock to the colored adhesive layer.

In one configuration, each backing region includes a colored ink. The color of the ink is at least similar to the flock fibers in the corresponding flock region.

In accordance with another embodiment, at least some of the flock fibers have a non-cylindrical shape, such as a tri-lobal shape, that directs a substantial amount of light to the fiber surface, provides additional surfaces from which light can reflect for maximum brilliance, and diffuses only a relatively small amount of light.

The use of bright luster fibers with matching color adhesive backing can offer at least the following advantages: a highly rich color intensity, and a shiny fiber coating that is similar to high-perceived-value embroidery. It can also provide a product that can be embossed, which re-orients the fibers to show even more of a “side view,” and therefore the sheen of the bright fiber not normally seen from a cut-ends view. The use of underlying multi-colored adhesives that are color matched to bright-lustered flock fibers when compared to conventional flocked articles using dull lustered flock fibers and an off-color adhesive, or a differently colored backing adhesive, can permit the use of lower flock densities and longer flock fibers while still providing a plush “feel.”

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below. Other advantages will be apparent to one of ordinary skill in the art from the disclosure provided below.

### BRIEF DESCRIPTION OF THE DRAWINGS

FIG. 1 is a plan view of a flocked article according to an embodiment of the present invention;

FIG. 2 is a side view of a flocked transfer according to an embodiment of the present invention;

FIG. 3 is a side view of the flocked transfer without the carrier sheet and release adhesive;

FIG. 4 is a flow chart of a manufacturing process for the flocked transfer of FIG. 2;

FIG. 5 is a side view of a direct flocked article according to an embodiment of the present invention;

FIG. 6 is a flow chart of a manufacturing process for the direct flocked article of FIG. 5;

FIG. 7 is a side view of a manufacturing line for the flocked articles according to an embodiment of the present invention;

FIG. 8A is a flow chart of a manufacturing process for the flocked article of FIG. 8B;

FIG. 8B is a side view of a flocked transfer according to another embodiment of the present invention;

FIG. 9A is a flow chart of a manufacturing process for the flocked article of FIG. 9B;

FIG. 9B is a side view of a flocked transfer according to another embodiment of the present invention; and

FIG. 10 is a side view of a flocked transfer according to another embodiment of the present invention.

### DETAILED DESCRIPTION

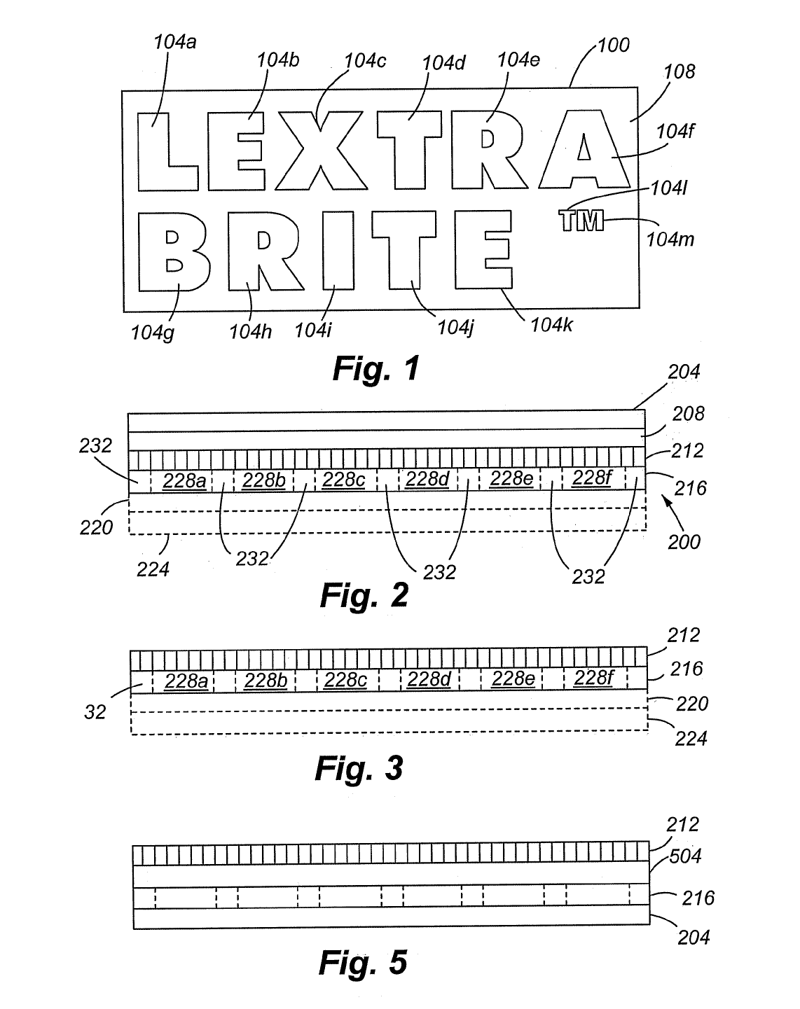

FIG. 1 shows a flocked article 100 according to an embodiment of the present invention. The flocked article 100 comprises two different colored regions, namely lettered areas 104a-m having a first color and a background region 108 having a second color. The lettered areas 104a-m and the background region 108 includes a plurality of flock fibers, colored inks or colored adhesives, such as colored latex adhesives. For example, both the flock and at least a portion of the underlying adhesive in the lettered areas 104a have substantially the same (first) color and that in the background region 108 substantially the same (second) color. In this way, the adhesive will “blend in” with, and visually highlight the flock.

The flocked article 100 uses flock fibers having a bright luster and having little, if any, dulling light dispersants, such as a white pigment (i.e. titanium dioxide) to enable a substantial amount of light to travel through the fiber. As used herein, the term “luster” refers to the degree of reflectance and scattering of light on the surface of the fiber. The light scattering ability of a flock fiber is directly dependent on the amount of light dispersants in the flock fiber. Fibers with higher amounts of light dispersants, for example, will scatter more light than those with lower amounts of light dispersants. Preferably, the flock fibers of the present invention have, at most, only a small amount of the light dispersants, and thus have a low light scattering ability, and a relatively brilliant appearance. Reflected light appears more intense the less it is diffused or scattered.

FIG. 2 shows a flocked article 200 according to another embodiment of the present invention. The article 200 includes a carrier sheet 204, release adhesive layer 208, flock layer 212, and first, second, and third adhesive layers 216, 220, and 224 (with the second and third adhesive layers 220 and 224 being optional). As can be seen from FIG. 2, the flock fibers in the flock layer 212 are substantially perpendicular to the planes of the carrier sheet 204 and adhesive layers 216, 220, and 224 to provide a plush feel. To adhere the article 200 to a desired substrate, the adhesive layer 224 is placed against the substrate (not shown) surface, and heat and pressure applied to the carrier sheet 204. The heat will melt, at least partially, the third adhesive layer 224. When the heat is removed, the third adhesive layer 224 will adhere reversibly (but permanently absent remelting) to the substrate.

The carrier sheet 204 can be any desirable sacrificial carrier, such as cellulose (paper), microporous substrate (such as described in U.S. Pat. No. 6,025,068, U.S. patent application Ser. No. 09/621,830; and copending U.S. Provisional Application Ser. Nos. 60/628,836, filed Nov. 16, 2005; 60/676,124, filed Apr. 28, 2005; 60/703,925, filed Jul. 28, 2005; 60/704,681, filed Aug. 1, 2005; 60/707,577, filed Aug. 11, 2005; 60/710,368, filed Aug. 22, 2005; 60/716,869, filed Sep. 13, 2005; 60/719,469, filed Sep. 21, 2005; and 60/719,098, filed Sep. 20, 2005, to Abrams, each of which is incorporated herein by this reference), and other known carriers. The release adhesive 208 can be any suitable adhesive, such as those disclosed in any of the above copending U.S. applications.

The flock 212 used in any of the processes discussed herein can be any electrostatically chargeable fiber, such as fibers made from rayon, nylon, cotton, acrylic, and polyester, with rayon and nylon being preferred. The flock fibers 212 preferably have a bright luster as opposed to a dull or semi-dull luster. As will be appreciated, the “luster” refers to the reflectance and scattering of light on the surface of the fiber. For example, dull looking nylon lacks luster, is very flat, and has a high degree of light scattering behavior. Nylon with a bright luster is shiny and sparkly, with a small degree of light scattering behavior. The light scattering ability of the flock fiber is dependent directly on the amount of light dispersants (primarily white pigment (e.g., titanium dioxide)) in the flock fiber. Fibers with higher amounts of white pigment scatter more light than those with lower amounts of white pigment. Preferably, the flock fibers have, at most, only a small amount of the white pigment and have a low light scattering ability. The flock fibers 212 preferably have a bright luster as opposed to a dull or semi-dull luster. Thus, the fibers 212 preferably have no more than about 0.1 wt. % light dispersants, and more preferably no more than about 0.05 wt. % light dispersants. In one embodiment, the white pigment is titanium dioxide. The absence of the light dispersants, such as white pigment, further eliminates unsightly shading or shadowing caused by light passing through the fibers.

The first adhesive layer 216 may comprise any type of colored adhesive, such as water-based or solvent-based epoxies, phenoformaldehyde, polyvinyl butyral, cyanoacrylates, polyethylenes, isobutylenes, polyamides, polyvinyl acetate, latexes, acrylics, and polyesters, and can exhibit thermoplastic and/or thermoset behavior. In one embodiment, the first adhesive layer includes a UV-curable adhesive that can be solidified by irradiation with UV light. In another embodiment, the first adhesive layer 216 includes a latex adhesive. In yet another embodiment, the first adhesive layer 216 includes a plastisol adhesive. As will be appreciated, “plastisol” is a dispersion of finely divided resin in plasticizer that forms a paste that solidifies when heated above a set temperature as a result of solvation of the resin particles by the plasticizer.

As can be seen from FIG. 2, the first adhesive layer 216 has a plurality of differently colored areas that coincide and are in registration, with the flock fibers. First regions 228a-f may have substantially the same color as and underlie the flock fibers in the lettered areas 104a-m, and the second region 232 may be substantially the same color as and underlie the flock fibers in the background region 108. Alternatively, the first regions 228 a-f may have a similar color as and underlie the flock fibers in the lettered areas 104a-m, and the second region 232 may be a similar color as and underlie the flock fibers in the background region 108. Further, first regions 228 a-f may have a color of a different shade as and underlie the flock fibers in the lettered areas 104a-m, and the second region 232 may be a similar color, but a color of a different shade as and underlie the flock fibers in the background region 108. In this latter embodiment, an aesthetically pleasing effect may be obtained by providing a light blue fiber and a navy blue adhesive underlying an end of the fiber, a light green fiber with a dark green adhesive, and the like. By color matching the bright lustered flock fibers and its underlying adhesive, the present invention provides a flocked article having a brilliant appearance and reduces the need for substantial flock densities to mask the underlying adhesive.

The optional second adhesive layer 220 and optional third adhesive layer 224 may include any suitable adhesive and preferably include a substantially transparent, translucent, and/or clear adhesive that can exhibit thermoplastic or thermoset behavior. Examples of suitable adhesives include water-based or solvent-based epoxies, phenoformaldehyde, polyvinyl butyral, cyanoacrylates, polyethylenes, isobutylenes, polyamides, polyvinyl acetate, latexes, acrylics, and polyesters.

In one embodiment, the third adhesive layer 224 is a thermoplastic and/or a thermosetting adhesive. The third adhesive may be a thermoplastic adhesive in the form of a powder, liquid, or a pre-formed, solid, and/or self-supporting sheet. In a particular embodiment, the adhesive is a thermoplastic adhesive powder, such as a powdered hot-melt adhesive. As will be appreciated, a hot-melt adhesive quickly melts upon heating and sets to a firm bond on cooling. Most other types of adhesives set by evaporation of solvent. Particularly preferred hot-melt adhesives include polyethylene, polyvinyl acetate polyamides, and hydrocarbon resins. The third adhesive may melt at low temperatures to bond to a desired substrate (not shown) on one side thereof and the flock, colored adhesive, and second adhesive (if provided) on an opposed side. Thus, in one embodiment, the flocked article may further include a substrate having ends of the flock bonded thereto by any one of the colored, second, and third adhesives.

FIG. 3 depicts the flocked transfer without the carrier sheet 204 and release adhesive 208.

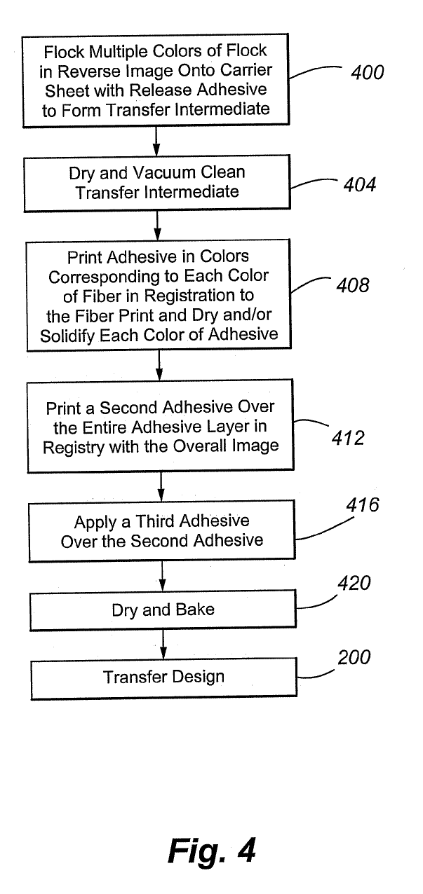

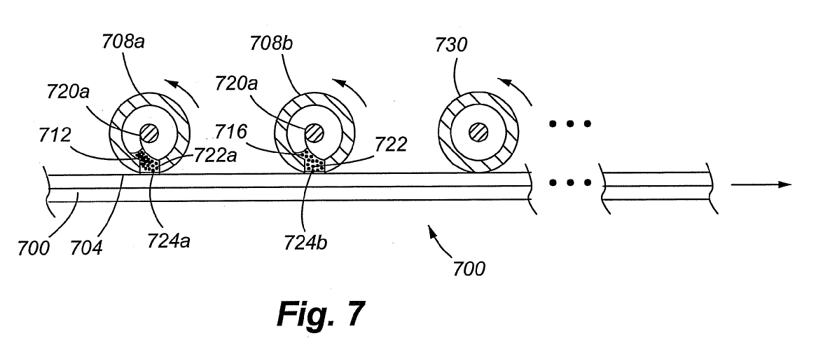

A system and process for manufacturing the article 200 will now be discussed with reference to FIGS. 4 and 7.

In step 400, a flocked transfer intermediate is formed by applying the flock fibers to a carrier sheet 204 covered with a release adhesive 208. The flock may be applied to the release adhesive covered carrier sheet by a number of techniques. For example, the flock may be applied mechanically (including drop, vibration, windblown, or a combination thereof) or electrostatic techniques (including AC or DC electrostatic and air assist techniques). The intermediate is preferably formed by screen printing the release adhesive in a desired pattern (which is typically the reverse of the desired final flock pattern) on the carrier sheet followed by electrostatically flocking the carrier sheet.

In step 404, the intermediate is dried and vacuum cleaned to remove loose flock fibers.

In step 408, the first adhesive is printed onto the ends of the flock 212 in colors corresponding to the colors of the adjacent fibers and in a pattern in registration to the fiber print. The various colored backing adhesives may be printed, simultaneously and in one pass, on a carousel type machine, for example, that when compared to separate printing operations, can be cheaper and easier to register the colors together. The adhesives can be printed, either “wet on wet” (one color after another like a t-shirt printing machine), or in a continuous print/dry/print/dry type cycling that dries each color prior to printing the next one so that the adhesive does not begin to adhere and build up on the screens. When wet adhesive is printed onto wet adhesive, the previously printed wet adhesive will typically stick to the bottom of the subsequent printing screen. To avoid intermixing of the differently colored wet adhesives and/or building up on the bottom of the printing screen and/or plugging up of the printing screen, which may cause the screen to become uneven or moved out of alignment; one embodiment of the present invention provides that the various colored adhesives are dried and/or solidified (such as by forming a film over the previously applied wet adhesive prior to applying the next wet adhesive), in whole or part, between applications.

To adhere the article 200 to a desired substrate, the adhesive layer 224 is placed against the substrate surface (not shown), and heat and pressure applied to the carrier sheet 204. The heat will melt, at least partially, the third adhesive layer 224. When the heat is removed, the third adhesive layer 224 will adhere reversibly (but permanently absent remelting) to the substrate.

An apparatus for performing the printing of the adhesives is depicted in FIG. 7. Although FIG. 7 depicts a rotary printing machine, it is to be understood that any type of printing machine may be used. The apparatus includes an endless band 700 tensioned between two deflecting rollers (not shown) that move synchronously. The surface 704 to which the adhesive is applied (which in the embodiment of FIG. 2 is the flock 212 layer) faces upward and the assembly including the surface rests on the band 700. The apparatus includes a plurality of rotatably mounted, identically radiused cylinders or motif generators 708a-b positioned above the surface 704 followed by a cylinder 730. The cylinders 708a-b and 730 define one cylinder set for depositing a selected color and pattern of (first) adhesive. The cylinders 708a-b and 730 move synchronously, and the cylinders 708a-b carry motif generators in the form of stencils. The first cylinder 708a in each cylinder set has inside of it a corresponding color of flowable liquid adhesive 712 for printing in a desired pattern on the surface 704. The second cylinder 708b has inside of it a substance 716 that solidifies the previously applied liquid adhesive and/or forms a skin on the previously applied liquid adhesive. Stated another way, the substance is applied over and in the same pattern as the pattern of the adhesive applied by the immediately preceding cylinder 708. Thus, the first and second cylinders apply, respectively, adhesive and the substance in the same pattern in an overlapping relationship; that is, the patterns are in registration with one another.

A stationary ducter 720 positioned in the central portion of each cylinder supplies the adhesives and substances. During each revolution, the adhesive or substance, as the case may be, exits a corresponding orifice 722 and screen 724. Typically, in a cylinder set, the orifice 722 of the adhesive-depositing cylinder is slightly smaller than the orifice 722 of the substance-depositing cylinder so that the substance is deposited over the entire areal extent of the wet adhesive. In the cylinders, the ducter spreads out the adhesive or substance, as the case may be, over the corresponding orifice, which guides the liquid onto and through the corresponding screen and onto the surface.

In one embodiment, the substance contains a solidifying agent that causes the adhesive to solidify, in whole or part, before the next cylinder applies a next liquid adhesive of a different color. The use of a solidifying agent permits the various colors of adhesives to be applied relatively rapidly, one after the other, generally without significantly increasing the incidence of clogging of the adhesive depositing stations. As will be appreciated, such clogging is typical when printing one wet adhesive in proximity to another wet adhesive.

Any solidifying agent suitable for the selected adhesive chemistry may be employed. In one embodiment, the substance includes a metal salt, and preferably a bivalent and/or trivalent metal salt on a base of a metal from Groups IA (alkali metals), IIA (alkaline earth metals), VIIB, VIIIA, IB, IIB, and IIIB of the Periodic Table of the Elements (Previous IUPAC form), and even more preferably a metal salt of magnesium and/or calcium and/or aluminum.

In another embodiment, the adhesive includes an alginate compound before application (which is a derivative of alginic acid (e.g., calcium, sodium, or potassium salts or propylene glycol alginate)). As will be appreciated, alginates are normally hydrophilic colloids (hydrocolloids) obtained from seaweed. Sodium alginate, in particular, is water-soluble but reacts with calcium salts to form insoluble calcium alginate. As will be appreciated, alginates are normally hydrophilic colloids (hydrocolloids) obtained from seaweed. Sodium alginate, in particular, is water-soluble but reacts with calcium salts to form relatively insoluble calcium alginate salts.

In yet another embodiment, the substance includes a metal salt and an alginate as described above. When contacted with one another, the metal salt and alginate react to form at least one of a substantially transparent and a translucent film.

In one configuration, an alginate compound may be provided in the flowable liquid adhesive 712. The metal salt may thereafter be applied over the liquid adhesive. The metal salt and alginate compound then react to form a substantially transparent film or skin over the colored adhesive. The skin forms instantaneously on the liquid adhesive before the adhesive contacts the next cylinder 730. This skin is preferably smooth, and at least one of substantially transparent and substantially translucent such that the adhesive is not disturbed. Moreover, the skin is thin and normally does not smear. To avoid clogging of the orifice of the substance-depositing cylinders at the edges, the orifice is made sufficiently large such that the orifice does not contact the front and rear edge of the previously applied adhesive pattern. Otherwise, the reaction between the alginate and the metal salt would likely clog the orifice.

The cylinder 730 is shown merely diagrammatically. It has the same structure as the other cylinders in the cylinder set. However, the orifice of the cylinder 730 may be angular at another location, as there is no intent to print over the previously deposited adhesive. The adhesive is preferably neither pressed (squeezed) into the surface by the cylinder 730, nor does it remain adhering to the circumference of the cylinder 730. To the contrary, the various (first) adhesives may travel through undamaged under the cylinder 730. The (outer) skin has self-sealing properties. Even if the skin were to burst, as a result of the pressure of the cylinder 730, the small hole or crack would instantly close again, and a minimum outgrowth would occur. Enough alginate and metal salt still remains to ensure that the skin formation can occur repeatedly without mishap. As will be appreciated, the cylinder 730 follows each substance-depositing cylinder.

When the colored adhesives include a plastisol, the adhesives may alternatively be flash cured between adhesive applications or after one color adhesive is deposited and before the next color adhesive is deposited. Quick-drying of each adhesive (i.e., latex adhesives), color may be accomplished by “flash” drying units, commonly used by screen printers, or could be accomplished by using “UV adhesives” and/or radiation curable adhesives, that is, adhesives that use ultraviolet light or other radiation sources to initiate curing and allows for the formation of a permanent bond without heat. The different colored adhesives may have the same functionality or adhesion as the “bond” adhesive used in conventional flock transfers; that is, the functionality is to adhere to flock fibers on one side and a thermoplastic adhesive powder or film, for example, on the other side.

In another apparatus configuration, the metal salts can be applied over the entire width of the surface 704 by the use of an applicator (not shown). The surface 704 is thereby impregnated with a layer of the metal salts. The adhesive-applying cylinders deposit their respective adhesive patterns containing the alginate compound into the salt layer. The above reaction between the alginate compound and the metal salt then occurs to form a skin layer over the colored adhesive as discussed previously. In this apparatus configuration, the first cylinder deposits the substance over the areal extent of the first adhesive layer and the following cylinders thereafter apply the desired colors and patterns of (first) adhesives without being followed by a corresponding substance-depositing cylinder. The apparatus configuration of these configurations are discussed in GB 2,227,715 to Hechler, which is incorporated herein by this reference.

In yet another apparatus configuration, dryers and/or UV or radiation curing devices are positioned between the first and third cylinders in each cylinder set. In other words, a dryer or UV or radiation curing device is positioned in lieu of the substance-depositing cylinder in each cylinder set, rather than using a solidifying agent to cure (and in the case of the dryer, dry) the adhesive before the next differently colored is applied. Generally, the dryer configuration has much slower printing or web speeds compared to the prior cylindrical apparatus configurations using solidifying agents. The UV and radiation curing devices, depending upon the adhesive chemistries, can have faster printing and web speeds.

In step 412, after all of the differently colored adhesives are printed onto the corresponding fiber colors, the (optional) second adhesive 220 is printed over the entire design area (or over all of the first adhesives in the first adhesive layer) and in registry with the overall image. The printing of the second adhesive may be performed by any suitable method known in the art.

In step 416, the third adhesive is applied to the second adhesive and, in step 420, the transfer design 200 is heated (or irradiated) to dry and bake (or cure) the various adhesives. One skilled in the art would appreciate the desirable temperatures and residence times of this step.

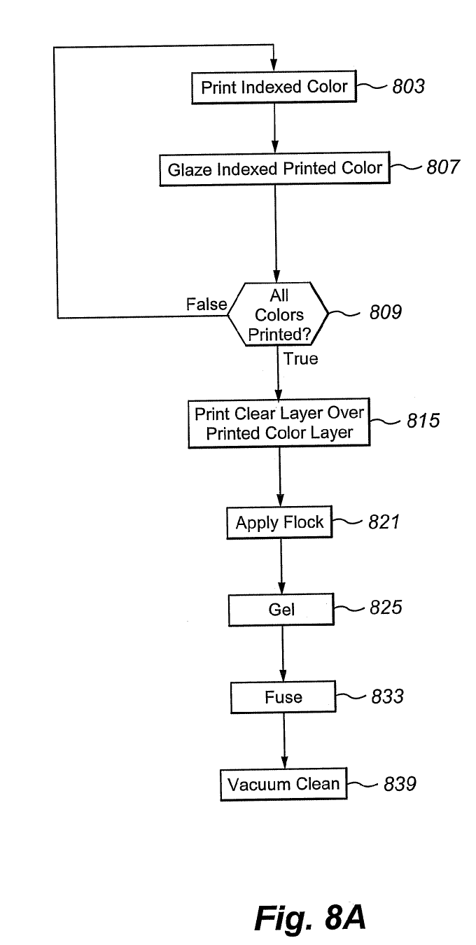

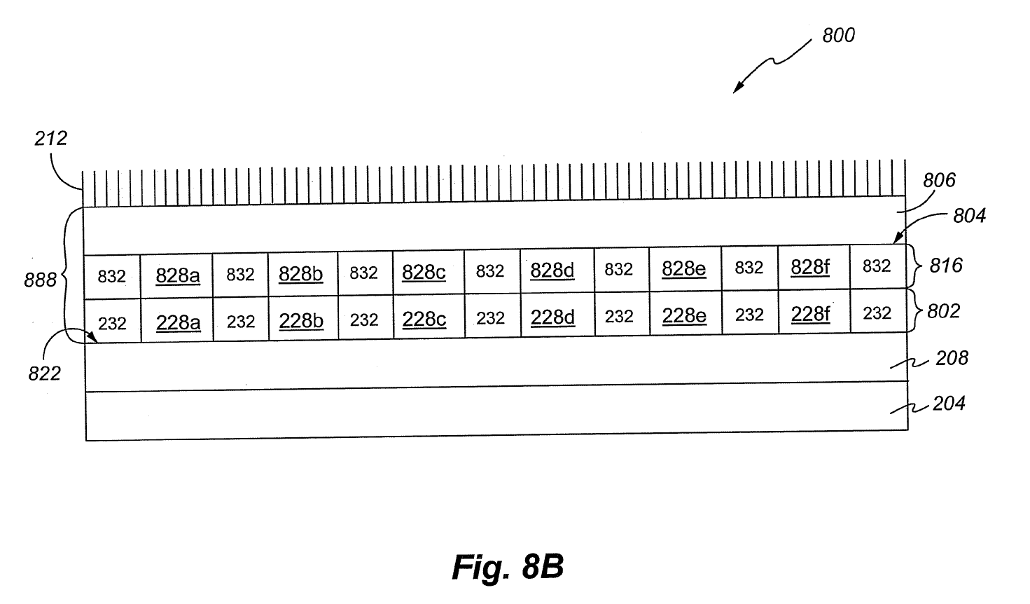

FIG. 8B shows a flocked article 800 according to another embodiment of the present invention. The article 800 includes a carrier sheet 204, a release adhesive layer 208, a flock layer 212 and a first (802) and second (806) (liquid, semi-liquid or solid) resin dispersion adhesive layer screen printed using an image screen onto the upper surface 822 using known techniques. A glazing layer 816 is applied to the first resin dispersion adhesive layer 802 between applications of differently colored areas of the layer 802. Flock 212 can be applied to the ungelled and unfused wet and tacky second resin dispersion layer 806 in desired areas by known techniques.

Preferred resins in suitable resin dispersions include vinyls, such as plastisol (which comprises a polyvinyl chloride resin), urethanes, nylons, acrylics, acetates and/or olefins. The resin dispersion can be any resin dispersion that will produce a resin film after fusing having desired characteristics. Considerations in formulating resin dispersions include screen printability, desired softness, desired thickness, color or other special effects (for example, such as the inclusion of glitter particles), acceptability and permanent adhesion of flock fibers, wash fastness, tensile strength, ability to be formed, welded and cut with a metal die in the high frequency field, and satisfactory adhesion when welded onto a desired substrate. To provide a high tensile strength, the resin dispersion typically includes at least about 0.1 wt. %, more typically at least about 0.5 wt. %, and even more typically from about 0.5 to about 2.5 wt. % of a curing agent. Typically, the resin film will have a tensile strength similar to that of commonly available calendared, cast, and/or extruded films and greater than tensile strength of PLASTISOL™ transfer ink films. Preferably, the tensile strength of the resin film is at least about 500 psi and more preferably ranges from about 600 to about 1,000 psi.

The decorative medium is preferably flock applied by multicolor direct electrostatic fiber coated heat transfer printing such as described in U.S. Pat. Nos. 4,810,549; 5,207,851; 5,047,103; 5,346,746; 5,597,637; 5,858,156; 6,010,764; 6,083,332; and 6,977,023, all of which are incorporated herein by this reference. Although flock is preferred, any decorative medium may be employed.

As will be appreciated, the gel temperature or gel point is the temperature at which the resin dispersion starts to become a solid. The gel point of a resin dispersion determines how fast the resin dispersion will flash (or the liquid component(s) vaporize) at a given thickness. A thinner film will flash more quickly than a thicker film as there is less material.

The fused stage temperature of a resin dispersion is that temperature necessary to fuse completely, or at least substantially, the resin dispersion. This temperature is typically dictated by the resins and plasticizers in the formulation and is typically 320° F./160° C. (dwell or residence time). Typically, the heating temperature is at least about 340° F. and more typically ranges from about 320° F. to about 370° F. The residence time is typically at least about 0.5 minute and more typically ranges from about 1 to about 3 minutes.

Referring to FIG. 8A, in step 803 a resin dispersion adhesive is applied discontinuously (e.g. screen printed) onto the release adhesive 208 in a desired registered pattern or shape or design to form the first layer 802. As can be seen from FIG. 8B, the first adhesive layer 802 has a plurality of differently colored areas or regions 228 and 232 that are in color registration with the flock fibers. First region has segments 228a-f having the same color as and underlying the flock fibers in the lettered areas 104a-m (FIG. 1), and the second region 232 may be substantially the same color as and underlies flock fibers in the background region 108 (FIG. 1).

In step 807, the glaze layer 816 is screen printed discontinuously onto the wet resin dispersion adhesive layer 802, typically in the same color registered pattern as the wet resin dispersion adhesive layer 802. The glaze region 832 corresponds to the commonly colored resin dispersion regions 232, and glaze regions 828a-f correspond to the, preferably, commonly colored resin dispersion adhesive regions 228a-f. After the first colored resin dispersion adhesive region 228 is screen printed, the glaze region 828 is applied, and after the second colored dispersion region 232 is screen printed, the glaze region 832 is applied. Stated another way, either the first or second colored resin dispersion adhesive region 228 or 232 is deposited followed by the deposition, on top of the first or second colored resin dispersion adhesive region 228 or 232, of the corresponding glaze region 828 or 832, respectively. The glazing agent causes a solid or semi-solid film to form on top of the otherwise wet region 228 or 232 and permits further screen printing of another, differently colored resin dispersion region. Then, the other of the first or second colored resin dispersion adhesive region 228 or 232 is deposited followed by the deposition, on top of the other of the first or second colored resin dispersion region 228 or 232, of the corresponding glaze region 828 or 832, respectively.

Step 809 is a logical test to assure that each color of resin dispersion adhesive is printed. When logical test 809 is false, steps 803 and 807 are repeated for a color resin dispersion adhesive remaining to be printed. When logical test 809 is true, a clear resin adhesive layer 806 is printed in step 815 on the surface 804 of glazing layer 816, which lies atop and provides a solid or semi-solid film covering the color indexed, wet resin dispersion adhesive layer 816.

In step 821, flock 212 is applied by suitable techniques to the ungelled and unfused resin dispersion adhesive layer 806.

In step 825, the flocked assembly is heated to a sufficient temperature (above the gel stage temperature) to gel the first and second resin dispersion layers 802 and 806.

In step 833, the flocked assembly is heated to a sufficient temperature (above the fuse stage temperature) and held at the temperature for a sufficient time to fuse the gelled first and second resin dispersion adhesive layers 802 and 806. The fuse stage will occur not only within each layer but also between layers to form a composite layer 888 having a sufficient tensile strength to be removed from the primary carrier and resist normal tensile forces experienced during handling. The cumulative thickness of layer 888 is typically at least the thickness T_{R}.

The thickness T_{R} of the gelled and fused resin film preferably is at least about 2.5 mil, more preferably at least about 4 mil, and even more preferably ranges from about 5 to about 20 mil.

In step 839, the flock 212 is vacuum cleaned.

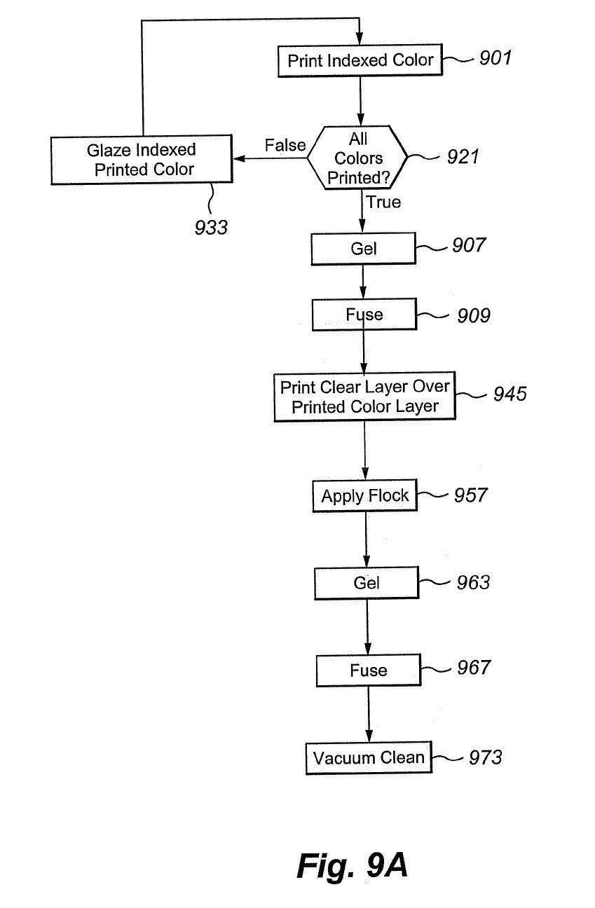

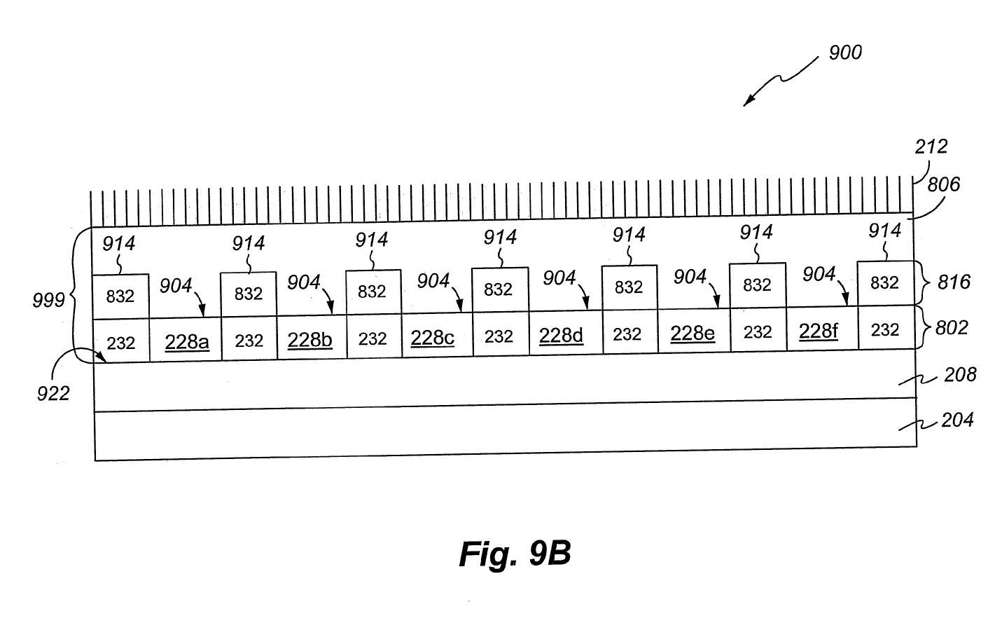

FIG. 9B shows a flocked article 900 according to another embodiment of the present invention. Article 900 includes a carrier sheet 204, a release adhesive layer 208, a flock layer 212, and a first (802) and a second (806) (liquid, semi-liquid or solid) resin dispersion layer screen printed (through an image screen) onto the upper surface 922 using known techniques. A glazing layer 816 is typically applied to the first resin dispersion adhesive layer 802 between applications of differently colored areas of layer 802. Flock 212 can be applied to the ungelled and unfused resin second resin dispersion layer 806 (which is wet and tacky) in desired areas by known techniques.

Referring to FIG. 9A, in step 901 a resin dispersion adhesive is applied discontinuously (e.g. screen printed) onto the release adhesive 208 in a desired registered pattern or shape or design to form the first layer 802. As can be seen form FIG. 9B, the first adhesive layer 802 has a plurality of differently colored areas or regions 228 and 232 that are in color registration with the flock fibers. First region has segments 228a-f having the same color as and underlying the flock fibers in the lettered areas 104a-m (FIG. 1), and second region 232 may be substantially the same color as and underlies flock fibers in the background region 108.

Step 921 is a logical test to determine if the last color has been printed; when logical test 921 is false, that is, at least one more differently colored resin dispersion adhesive remains to be printed, a glazing layer 816 is applied in step 933 to the first resin dispersion adhesive layer 802; glazing layer 816 is screen printed discontinuously onto the wet resin dispersion adhesive layer 802, typically in the same color registered pattern as the wet resin dispersion adhesive layer 802. The glaze region 832 corresponds to the commonly colored resin dispersion regions 232. After the first colored resin dispersion adhesive region 228 is screen printed and before the differently colored second resin dispersion adhesive regions 228a-f is screen printed the glaze region 828 is applied. FIG. 9B depicts a situation when two colors are being printed and when the first color resin dispersion adhesive printed is region 232, and the last color region printed is region 228a-f. Logical test 921 is true when the last color to be printed has been printed in step 901. The last color printed does not receive a glaze because it is gelled and fused in subsequent steps.

When logical test 921 is true, that is, the last remaining color to be printed was printed in the preceding step 901, the flock assembly is heated in step 907 to a sufficient temperature above the gel stage temperature to gel the first dispersion layer 802. In step 909, the flock assembly is heated to a sufficient temperature above the fuse stage temperature and held at the temperature for a sufficient time to fuse the gelled first dispersion adhesive layer 802.

A clear resin dispersion adhesive overlayer 806 is printed in step 945 on surfaces 904 and 914. Surface 914 is associated with glazing layer 816 applied to all but the last color printed. Surface 904 is associated with the layer 802 of the last color printed, a glazing layer is not applied to the last color printed in layer 802. Overlayer 806 lies atop and provides a sold or semi-solid film covering the color indexed layers 816 and 802.

In step 957, flock 212 is applied by suitable techniques to the ungelled and unfused resin dispersion adhesive layer 806.

In step 963, the flocked assembly is heated to a sufficient temperature above the gel stage temperature of layer 806 to gel layer 806.

In step 967, the flocked assembly is heated to a sufficient temperature above the fuse stage temperature of layers 806 and 802 and held at the temperature for a sufficient time to fuse layers 806 and 802. The fuse stage will occur not only within each layer but also between layers to form a composite layer 999 having a sufficient tensile strength to be removed from the primary carrier and resist normal tensile forces experienced during handling. The cumulative thickness of layer 999 is typically at least the thickness T_{R} (as defined above).

In step 973, the decorative media 212 is vacuum cleaned.

While FIGS. 8A and 9A show resin dispersion-type adhesives adhered directly to the flock or substrate, it is to be appreciated that other types of adhesives may be employed. Examples of other adhesives include those mentioned elsewhere in this application.

FIG. 5 depicts a design article 500 according to another embodiment of the present invention. The design article 500 differs from the transfer design of FIGS. 2-3 in that a flock adhesive layer 504 is positioned between ends of the flock and the (first) adhesive layer 216 and the carrier sheet 204 is positioned on the other side of the (first) adhesive layer 216. The flock adhesive 504 can be any suitable liquid adhesive for binding flock fibers together, including any of the adhesives referenced above.

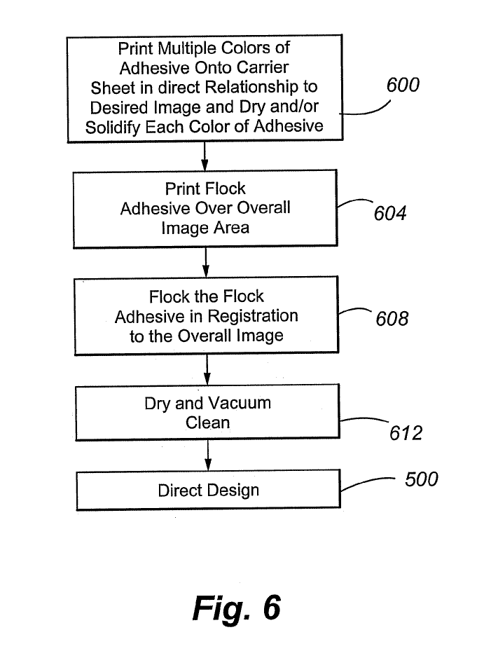

The process for manufacturing the article 500 will now be discussed with reference to FIG. 6.

In step 600, multiple colors of adhesive are printed onto the carrier sheet 204 in a direct relationship to the desired image, and each color of adhesive is dried, solidified, and/or fused. This step can be performed using the techniques and the printing apparatus 700 described above.

In one embodiment, the adhesive is in the form of a resin dispersion that may be solidified using heat or high frequency energy as set forth in copending U.S. Pat. No. 6,977,023, the entirety of which is incorporated by reference herein. Examples of suitable adhesives include high temperature adhesives, such as polybenzimidazoles and silica-boric acid mixtures or cermets, hot-melt adhesives, thermoset adhesives, and polyurethane. A particularly preferred adhesive is in the form of a resin dispersion is plastisol. The resin dispersion gels and/or fuses when heated or subjected to high frequency welding.

In step 604, the flock adhesive 504 is printed over the overall image area. Preferably, the flock adhesive 504 is at least one of clear, substantially translucent, and substantially transparent so as not to detrimentally impact the viewability or viewed color of the underlying (first) adhesives.

While the flock adhesive 504 is wet and tacky, in step 608, flock is flocked directly into the corresponding color of preprinted (first) adhesive. Each color of flock is flocked in a pattern in registry with a corresponding and at least similarly colored (first) adhesive. The at least similarly colored adhesive may be identical in color, substantially similar in color, similar in color, or similar in color but of a different shade, relative to the color of the corresponding flock fibers. In the latter embodiment, for example, a light blue fiber may be backed up with a navy blue adhesive, a light green fiber with a dark green adhesive, and so forth. An important aspect of the invention is using multiple colors of fiber with coordinated multiple colors of adhesive and brilliant, shiny, clear flock fibers. This is made possible by controlling the color of the underlying adhesive.

In step 612, the flock adhesive and colored adhesives are dried and/or solidified, if necessary, and the loose flock fibers removed by a vacuum or any other suitable device.

Particularly in apparel applications, dye can cause discoloration of the flock layer 212. The dye migrates from the textile substrate through the various adhesive layers 216, 220, and 224 and collects in the flock. As the amount of dye collected in the flock increases, the flock will become increasingly discolored.

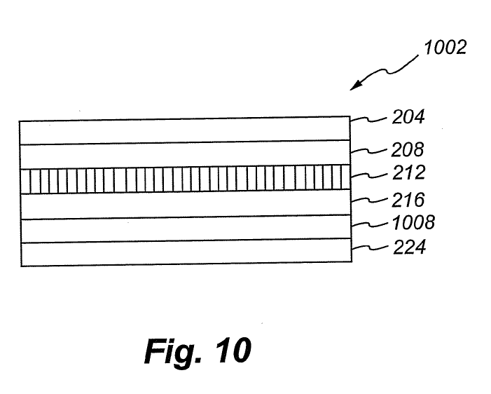

To address this problem, FIG. 10 depicts a flock transfer 1002 according to another embodiment. As can be seen in FIG. 10, the transfer 1002 includes the carrier sheet 204, release adhesive layer 208, flock layer 212, and first and third adhesive layers 216 and 224. In addition, the transfer 1002 includes a barrier layer 1008 to block substantially dye from a substrate (not shown) adhered to the third adhesive layer 224 from migrating through the layer and to the flock layer 212.

The barrier layer 1008 can be any suitable material that is substantially impervious to the passage of dye particles. In one configuration, the layer 1008 is an adhesive layer that includes a metal pigment dispersion agent, such as Rotovario 500, 530, 560, or 580™ by Eckart GMBH & Co. Kg. Such agents normally facilitate incorporating metallic pigments into the respective pigment formulation by eliminating the need to pre-wet and stabilize the pigment. Similar metal pigment dispersion agents are manufactured by Flex, BASF, and Schlenk. The amount of metal pigment dispersion agent varies but typically ranges from about 0.1 weight percent to about 50 weight percent of the layer 1008.

The layer 1008 is preferably deposited in the same manner as layer 216. In other words, the layer is preferably deposited in the same manner as is discussed with reference to FIG. 7. In addition to the metal pigment dispersion agent, a solidifying agent, preferably an alginate compound, is included in the flowable liquid adhesive used to form layer 1008. When the solidifying agent is an alginate compound, the metal salt may thereafter be applied over the liquid adhesive. The metal salt and alginate compound then react to form a substantially transparent film or skin over the colored adhesive. The skin forms instantaneously on the liquid adhesive before the adhesive contacts the next cylinder 730. In this way, layer 1008 may be printed in registration with and onto the layer 216 while layer 216 is still wet. This ability can not only increase the speed but also decrease the cost of transfer formation. Layer 1008 may be one or multiple colors in the same manner as layer 216. In one configuration, layer 216 is substantially transparent or translucent while layer 1008 is colored the same as the adjacent flock. Following the application of layer 1008, the third adhesive layer 224 is applied, preferably in the form of a powder.

A number of variations and modifications of the invention can be used. It would be possible to provide for some features of the invention without providing others.

For example, in one alternative embodiment, the multicolored first adhesives of first adhesive layer 216 are deposited on a carrier sheet and coated with a transparent adhesive in a first production line, a carrier sheet containing release adhesive is flocked in a second production line, and the free ends of the flock contacted with the transparent adhesive in a third production line to form a transfer having upper (top) and lower (bottom) carrier sheets. When the flock is contacted with the transparent adhesive, the flock image is in registry to the corresponding adhesive image. The transparent adhesive can then be heated and/or cured to permanently adhere the flock to the adhesive.

In another embodiment, decorative media other than flock can be used in the article in place of the flock layer 212. For example, glitter, glass beads, metal foil, and other decorative materials may be employed.

In yet another embodiment, the decorative articles of the present invention are manufactured using multicolor direct flocking, as opposed to heat transfer, prints, patches, and the like.

In still another embodiment, multicolor flocking is performed directly onto a release adhesive-coated carrier sheet. One overall thermoset adhesive, which may be in the form of a pre-formed, solid, continuous, and self-supporting sheet, is applied to free ends of the flock to provide strong functional flock adhesion thereto. Preferably, the depths to which the fibers penetrate into the adhesive are carefully controlled and are substantially uniform. Thereafter, each matching color is printed onto the thermosetting adhesive. The application of the various colors is then followed by lamination of a solid, self-supporting, and thermosetting sheet to the carrier sheet, thermoset adhesive layer, and matching colored adhesives.

In still another embodiment, multicolor flocking is performed directly onto a release adhesive-coated carrier sheet. One overall transparent, translucent, and/or clear adhesive, such as a latex adhesive, is printed onto the free ends of the flock to cover the entire flock, hold it together, and provide functional flock adhesion. Preferably, the depths to which the fibers penetrate into the adhesive are carefully controlled and are substantially uniform. This is considered to be best done by printing the adhesive in one pass. A one pass process is considered to be more practical than trying to print and control the depths to which up to six different colors of adhesives are penetrated by the flock fibers. The latex adhesive provides a flat, controlled surface for the printing of subsequent colors. Then, each matching color is printed onto the first clear layer. Application of the various colors are then followed by the application, to the colored layer, of either a final clear or white latex print followed by the application of a thermoplastic and/or thermosetting powder to the final latex print or by application of a pre-formed, solid adhesive film to the final latex print. The various colors may be in the form of colored adhesives, such as colored latex adhesives.

In one variation, the colored layer in which the desired multi-colored print is provided beneath the multi-colored flock is not formed from adhesive materials. Rather, the layer may be formed using colored materials other than colored adhesives, such as sublimation inks and water-based, acrylic emulsion, pigmented inks. The inks may be applied by any suitable printing technique, such as ink jet printing and screen-printing. In one variation, the colors are printed on the reverse of the transparent, translucent, and/or clear adhesive layer using the multi-pigment printing system of UK Patent 2,227,715. As noted above, in this system wet-on-wet ink printing is effected using the reaction between a bivalent and/or trivalent metal salt on a base of magnesium and/or calcium and/or aluminum and an alginate to form a protective film or skin on the previously applied ink before the next ink is applied.

In yet another embodiment, the alginate is printed onto the surface 704 while the metal salt is included in the adhesive. The layer of alginate previously coated onto the surface 704 will react with the metal salt in the adhesive when the adhesive is deposited to form the protective film or skin.

In any of the above embodiments, artistic colors of corresponding (overlapping) colored adhesive and flock areas do not need to be precisely matching. For example, a “frosted” effect may be desired for which a light red fiber may be backed up with a deep, dark red adhesive, a light yellow fiber with a bright yellow or golden yellow adhesive, and so forth. An important aspect of the invention is using brilliant, shiny, clear flock fibers, and coordinating multiple fiber colors with multiple adhesive colors, by controlling the color of the underlying adhesive and the luster of the flock fibers.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1.-20. (canceled)

21. An article, comprising:
a) a flocked transfer having a release adhesive positioned between a carrier sheet and a flock layer; and
b) a dye-blocking layer positioned between first and second adhesive layers, wherein the flock layer is positioned between the first adhesive layer and release adhesive and wherein the dye-blocking layer is substantially impervious to dye migrating therethrough.

22. The article of claim 21, further comprising a dye-containing substrate, wherein the dye-blocking layer is positioned between the dye-containing substrate and the flock layer and wherein the dye-blocking layer substantially inhibits migration of any contained within the substrate from the dye-containing substrate to the flock layer.

23. The article of claim 21, wherein the dye-blocking layer comprises a meal pigment dispersion agent dispersed throughout a third adhesive.

24. The article of claim 21, wherein the dye-blocking layer comprises a metal pigment dispersion agent.

25. The article of claim 24, wherein the metal pigment dispersion agent comprises from about 0.1 to about 50 weight percent of the dye-blocking layer.

26. The article of claim 21, wherein the flock layer comprises a plurality of flock regions, each flock region comprising flock fibers of substantially the same color, wherein each flock region has differently colored flock fibers relative to an adjacent flock region and wherein the dye-blocking layer comprises a plurality of dye-blocking regions, each dye-blocking region corresponding to a flock region and having a colored dye-blocking region, wherein a color of the dye-blocking region is at least similar to a color of the flock fibers in the corresponding flock region.

27. The article of claim 26, wherein the flock and dye-blocking layers comprise one or multiple colors.

28. The article of claim 21, wherein the first adhesive layer is one of substantially transparent and translucent.

29. The article of claim 21, further comprising a substrate, wherein the substrate is adhered to the second adhesive layer.

30. The article of claim 29, wherein the dye-blocking layer substantially blocks dye migrating from the substrate to the flock layer.

31. A method for making an article, comprising:
(a) applying a first adhesive layer to a first surface;
(b) applying a dye-blocking layer to the first adhesive; and
(c) applying a second adhesive layer to the dye-blocking layer, wherein the dye blocking layer is positioned between the first and second adhesive layers, wherein one of the following is true:
i) the first surface comprises flock fiber ends; and
ii) the method further comprises applying flock fibers to the second adhesive layer by one of flock transfer or direct flocking process.

32. The method of claim 31, wherein the dye-blocking layer comprises a metal pigment-dispersing agent.

33. The method of claim 32, wherein the metal pigment-dispersing agent comprises from about 0.1 to about 50 weight percent of the dye-blocking layer.

34. The method of claim 31, wherein the first and second adhesives are resin dispersions.

35. The method of claim 31, wherein i) is true.

36. The method of claim 35, wherein flock fibers are adhered to a carrier sheet by a release adhesive and wherein the flock fibers are positioned between the first adhesive and the release adhesive.

37. The method of claim 31, wherein ii) is true.

38. The method of claim 37, wherein the flock transfer comprises a carrier sheet adhered to the flock fibers by a release adhesive.

39. The method of claim 31, wherein the dye-blocking layer comprises a metal pigment-dispersing agent dispersed throughout an adhesive.

40. The method of claim 31, wherein the dye-blocking layer substantially inhibits migration of dye particles through the dye-blocking layer.
